(19) United States
(12) Patent Application Publication
(10) Pub. No.: US 2022/0390060 A1
(43) Pub. Date: Dec. 8, 2022

(54) SCREEN SUPPORT FRAME

(71) Applicant: OXTI CORPORATION, New Taipei City (TW)

(72) Inventor: Chih-Feng Ho, New Taipei City (TW)

(21) Appl. No.: 17/337,427

(22) Filed: Jun. 3, 2021

(51) Int. Cl. F16M 11/12; F16M 11/04; F16M 11/20

(52) U.S. Cl. CPC F16M 11/125; F16M 11/046; F16M 11/2014; F16M 2200/027

(57) ABSTRACT

A screen support frame includes a base and a supporting member that includes a supporting member mounting portion, which has one end mounted to the base and an opposite end formed with a protrusion, and a supporting member rotating portion including a receiving hole in which the protrusion of the supporting member mounting portion is received. The supporting member rotating portion includes rails, between which a longitudinally movable member is arranged. A frontward projection arm extends from one side of the longitudinally movable member. A screen fixing portion is mounted to the frontward projection arm of the longitudinally movable member of the supporting member rotating portion and includes symmetrically arranged elastic members and symmetrically arranged friction members. The screen fixing portion further includes a rotating disc. The present invention provides effects of adjusting of angle of rotation, vertical position, elevational angle, and sideway rotating angle.

### TECHNICAL FIELD OF THE INVENTION

The present invention relates to a support frame, and more particularly to a screen support frame.

### DESCRIPTION OF THE PRIOR ART

A support frame for supporting a screen is known, such as Taiwan Utility Model M599368. The known support frame comprises a base, a vertical pole, a connecting member, and a locking member. The vertical pole is mounted on the base and is connected by the connecting member to the locking member for being fixed, so that the support frame can be securely stood. A carrying member is provided on the vertical pole to receive a screen to position thereon so as to make a support frame for screens.

However, most of known screen support frames are structured to only allow adjustment in respect of a vertical position of the screen by means of a retaining member, such as a pin, a bolt, or a spring, provided on the vertical pole. Yet, some of the retaining means must be operated with an external tool for making such an adjustment. Further, most of the screen support frames are only adjustable for the vertical position of the screen. If a user attempts to make rotation for a different application or to otherwise adjust to a different angular position, there will be a situation that the known support frames do not support for such adjustment.

### SUMMARY OF THE INVENTION

In view of the above-discussed problems of the known screen support frame, an objective of the present invention is to provide a screen support frame.

To achieve the above objective, the present invention provides a screen support frame, which comprises:

a screen support frame, wherein the screen support frame comprises a base and a supporting member, the supporting member comprising a supporting member mounting portion and a supporting member rotating portion, the supporting member mounting portion having one end mounted to the base, the supporting member mounting portion having an opposite end on which a protrusion and a rotation stop are formed, the supporting member rotating portion comprising a receiving hole and receptacle formed therein, wherein the protrusion of the supporting member mounting portion is disposed in the receiving hole of the supporting member rotating portion and the rotation stop of the supporting member mounting portion is disposed in the receptacle of the supporting member rotating portion, so that the supporting member provides an effect of rotating; the supporting member rotating portion comprises a pair of rails and a longitudinally movable member arranged between the rails, the longitudinally movable member having a side surface from which a frontward projection arm extends outwards, the longitudinally movable member having an opposite side that is provided with a friction member and a plurality of elastic member receiving troughs, an enclosure being provided to enclose the supporting member rotating portion, a plurality of elastic members being arranged in an interior of the enclosure, the elastic members being respectively disposed in the elastic member receiving troughs of the longitudinally movable member to each provide a spring force, the enclosure being provided with a friction track, the friction track being arranged for contact engagement with the friction member of the longitudinally movable member to increase a frictional force.

Preferably, the longitudinally movable member is provided with a friction adjusting member. The friction adjusting member is arranged to push against the friction member to make adjustment of the frictional force between the friction member and the friction track for increasing or decreasing the frictional force.

A screen fixing portion is provided, and the screen fixing portion is mounted to the frontward projection arm of the longitudinally movable member of the supporting member rotating portion. The screen fixing portion is provided with a group of symmetric elastic members and a group of symmetric friction members, wherein the symmetric elastic members of the screen fixing portion provide spring forces and the symmetric friction members of the screen fixing portion provide frictional forces, both combined providing the screen fixing portion with an effect of adjusting an elevation angle of a screen attached thereto.

Preferably, the screen fixing portion is provided with a rotating disc, and the rotating disc allows the screen fixing portion to do rotation in a clock like fashion, so as to provide the screen fixing portion with an effect of adjusting sideway rotating angle.

Preferably, the supporting member is provided with a front cover and a rear cover. The front cover and the rear cover are arranged to mate each other to enclose around and house the supporting member therein.

In the present invention, the supporting member is structured such that the supporting member rotating portion is formed with the receptacle, while the supporting member mounting portion is provided with the rotation stop, so that the present invention achieves an effect of rotation. Further, in the present invention, the supporting member is structured to include the longitudinally movable member, and the longitudinally movable member applies a frictional force with respect to the friction member and the friction track of the enclosure by means of a spring force applied from the plurality of elastic members, so that the present invention achieves an effect of longitudinal movability. Further, the screen fixing portion is structured to include the symmetric elastic members and the symmetric friction members, and an effect of adjusting the elevational angle of the screen fixing portion is achieved. Further, the screen fixing portion is structured to include the rotating disc, and an effect of adjusting a sideway rotating angle of the screen fixing portion is achieved. In summary of the description provided above, the present invention may provide effects of adjustment of vertical position, elevational angle, sideway rotating angle, and angle of rotation.

### BRIEF DESCRIPTION OF THE DRAWINGS

FIG. 1 is a perspective view of the present invention.

FIG. 2 is an exploded view of the present invention.

FIG. 3 its a schematic view showing a supporting member rotating portion and a supporting member mounting portion according to the present invention in a detached manner

FIG. 4 is an exploded view of the supporting member rotating portion according to the present invention.

FIG. 5 is a schematic view illustrating assembling of an enclosure and a power member according to the present invention.

FIG. 6 is a schematic view, in an exploded form, showing a screen fixing portion according to the present invention.

FIG. 7 is a schematic view illustrating rotating of the supporting member according to the present invention.

FIG. 8 is a schematic view illustrating adjusting of vertical position of the supporting member according to the present invention.

FIG. 9 is a schematic view illustrating adjusting of elevational angle according to the present invention.

FIG. 10 is a schematic view illustrating adjusting of sideway rotating angle according to the present invention.

### DETAILED DESCRIPTION OF THE PREFERRED EMBODIMENT

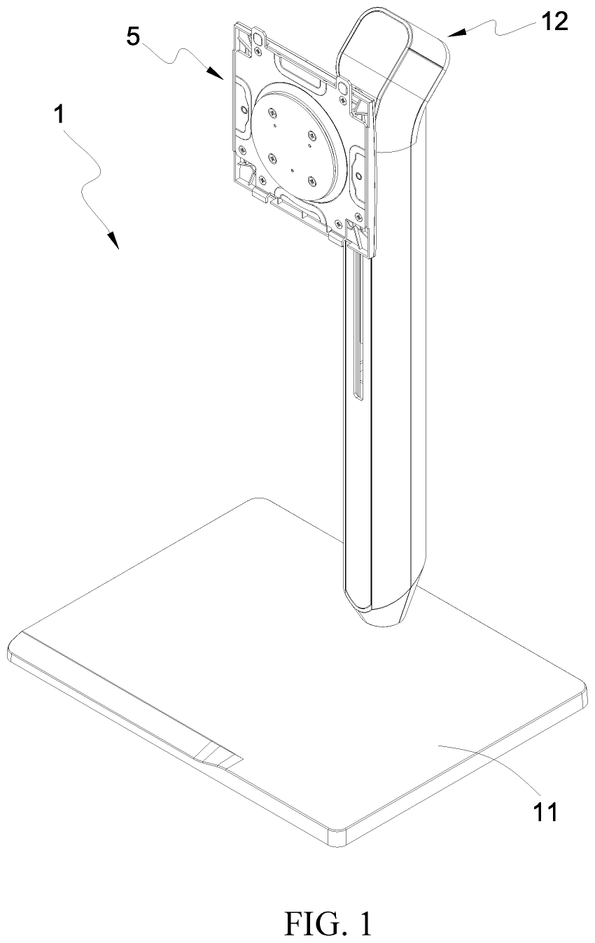

Referring to FIG. 1, a screen support frame comprises:

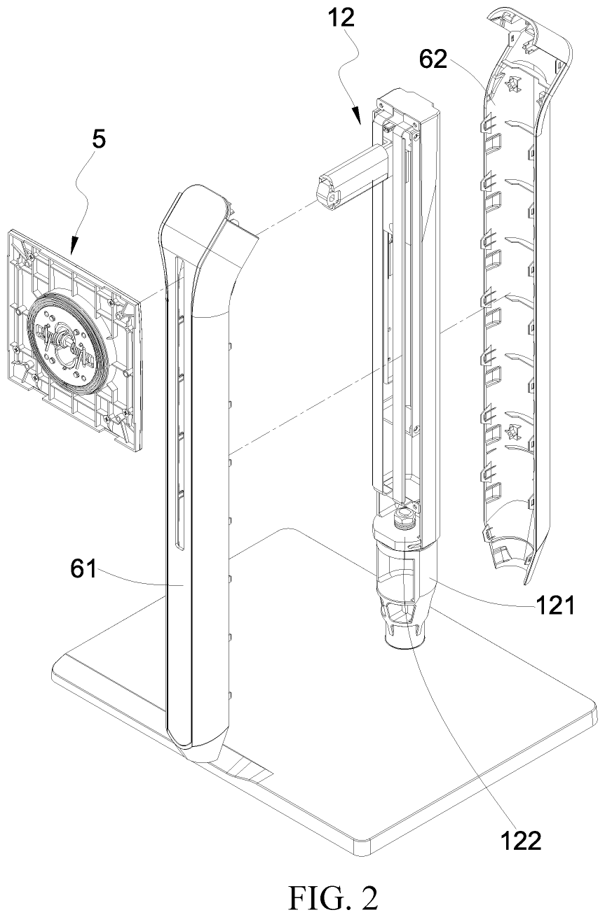

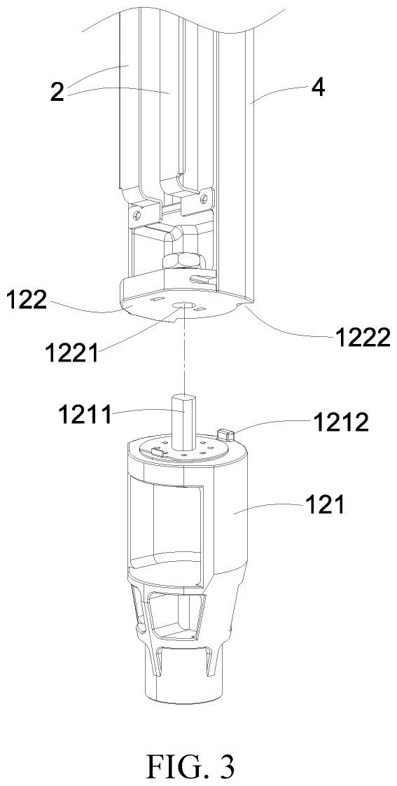

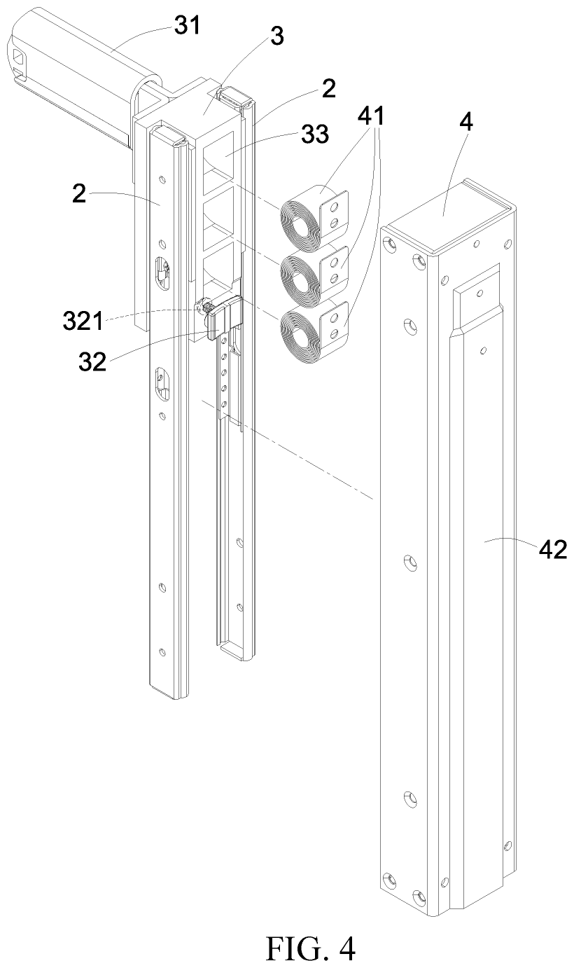

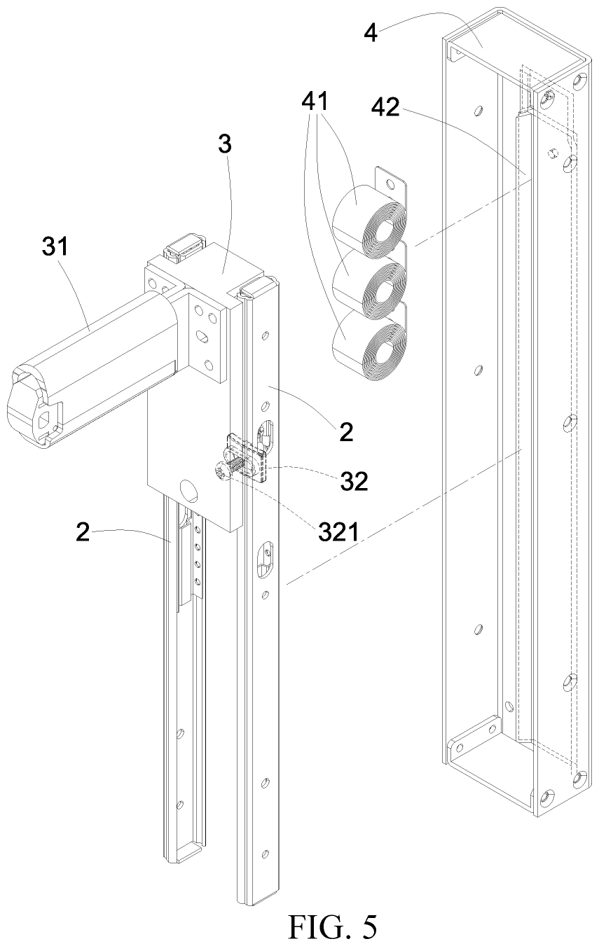

a screen support frame 1, wherein the screen support frame 1 comprises a base 11 and a supporting member 12, and, with reference being had to FIGS. 2 and 3, the supporting member 12 comprises a supporting member mounting portion 121 and a supporting member rotating portion 122, the supporting member mounting portion 121 having one end mounted to the base 11, the supporting member mounting portion 121 having an opposite end on which a protrusion 1211 and a rotation stop 1212 are formed, the supporting member rotating portion 122 comprising a receiving hole 1221 and a receptacle 1222 formed therein, wherein the protrusion 1211 of the supporting member mounting portion 121 is received and disposed in the receiving hole 1221 of the supporting member rotating portion 122, and the rotation stop 1212 of the supporting member mounting portion 121 is disposed in the receptacle 1222 of the supporting member rotating portion 122, so that the supporting member 12 may transmit an effect of rotation; with additional reference to FIGS. 4 and 5, the supporting member rotating portion 122 comprises a pair of rails 2, and a longitudinally movable member 3 is arranged between the rails 2, the longitudinally movable member 3 having a side surface from which a frontward projection arm 31 extends outward, the longitudinally movable member 3 having an opposite side that is provided with a friction member 32 and a plurality of elastic member receiving troughs 33, an enclosure 4 being provided to enclose the supporting member rotating portion 122, a plurality of elastic members 41 being arranged in an interior of the enclosure 4, the elastic members 41 being respectively disposed in the elastic member receiving troughs 33 of the longitudinally movable member 3 to each provide a spring force, the enclosure 4 comprising a friction track 42, the friction track 42 being provided for contact engagement with the friction member 32 of the longitudinally movable member 3 to increase a frictional force.

Preferably, the longitudinally movable member 3 is provided with a friction adjusting member 321. The friction adjusting member 321 is arranged to push against the friction member 32 to make adjustment of the frictional force between the friction member 32 and the friction track 42 for increasing or decreasing the frictional force.

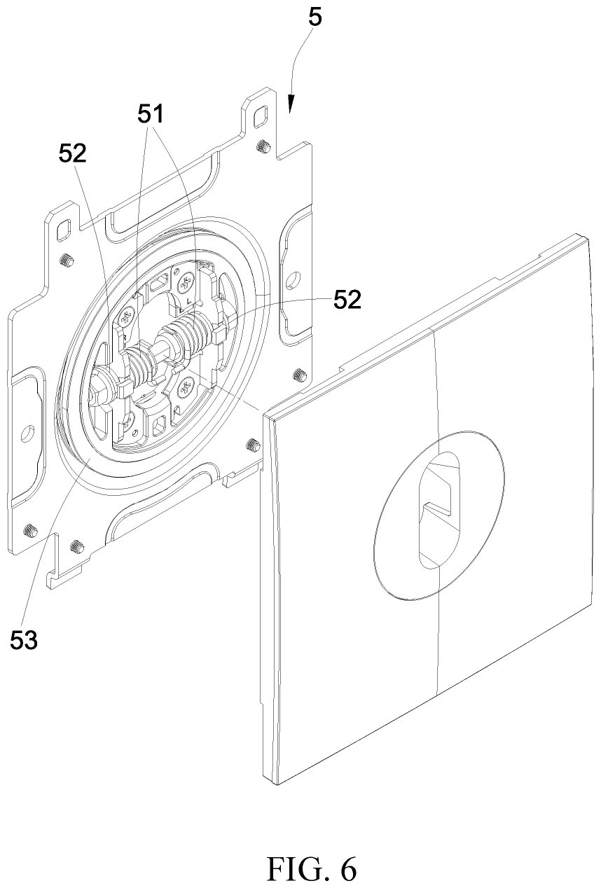

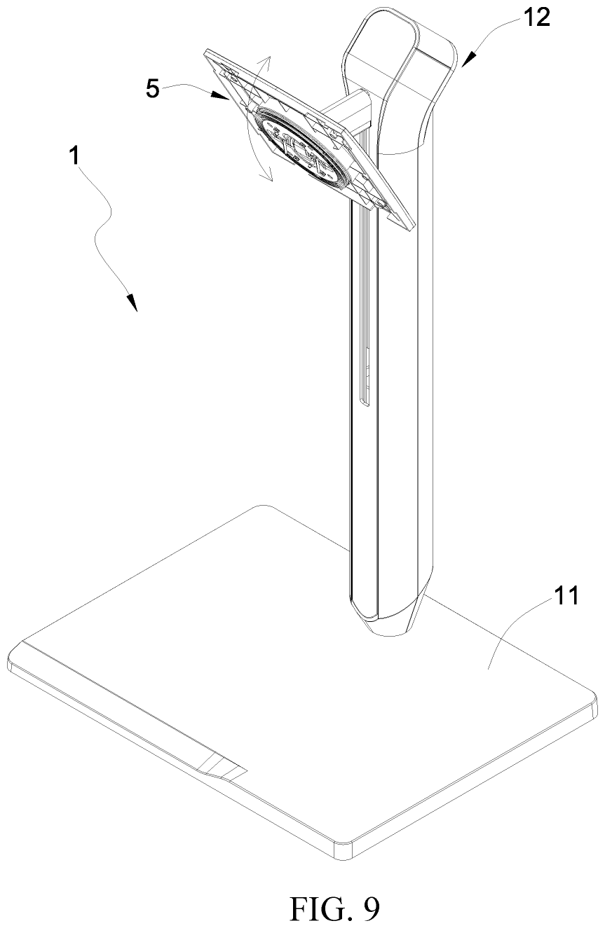

Further referring to FIGS. 5 and 6, a screen fixing portion 5 is provided, and the screen fixing portion 5 is mounted to the frontward projection arm 31 of the longitudinally movable member 3 of the supporting member rotating portion 122. The screen fixing portion 5 is provided with a group of symmetrically arranged elastic members 51 and a group of symmetrically arranged friction members 52, wherein the symmetric elastic members 51 of the screen fixing portion 5 provide spring forces and the symmetric friction members 52 of the screen fixing portion 5 provide frictional forces, both combined providing the screen fixing portion 5 with an effect of adjusting an elevation angle of a screen attached thereto, as shown in FIG. 9.

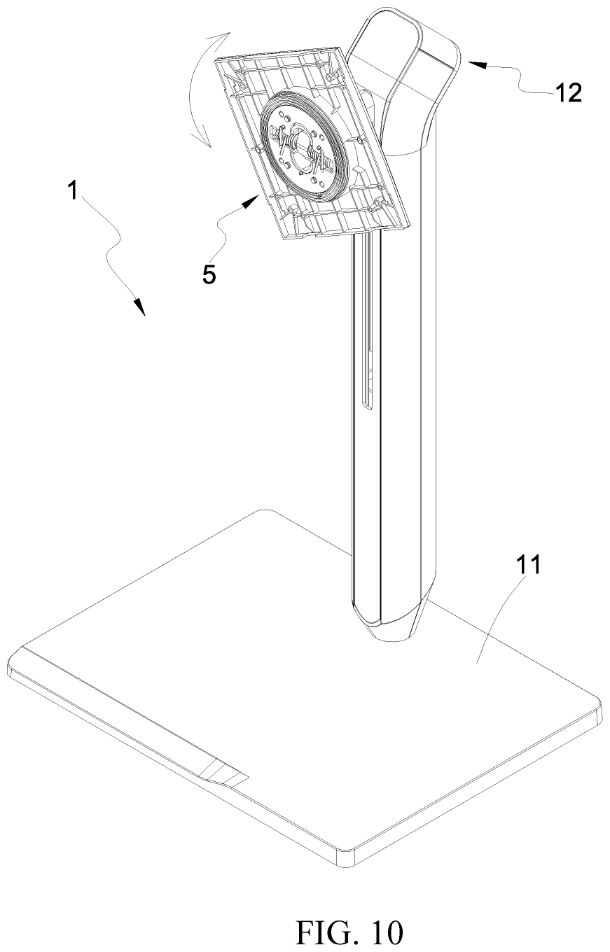

Preferably, the screen fixing portion 5 is provided with a rotating disc 53, and the rotating disc 53 allows the screen fixing portion 5 to do rotation in a clock like fashion, so as to provide the screen fixing portion 5 with an effect of adjusting sideway rotating angle, as shown in FIG. 10.

Preferably, the supporting member 2 is provided with a front cover 61 and a rear cover 62. The front cover 61 and the rear cover 62 are arranged to mate each other to enclose around and house the supporting member 12 therein, as shown in FIG. 2.

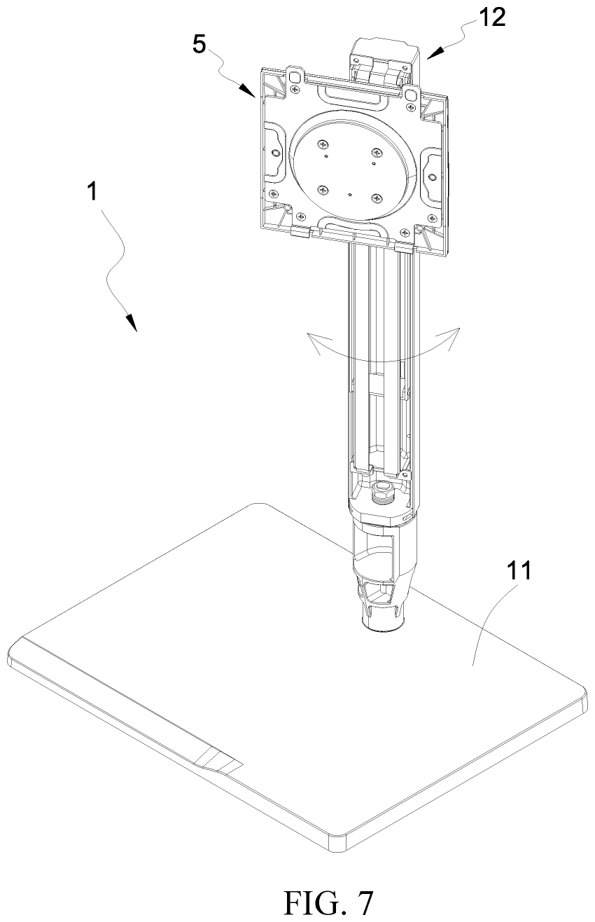

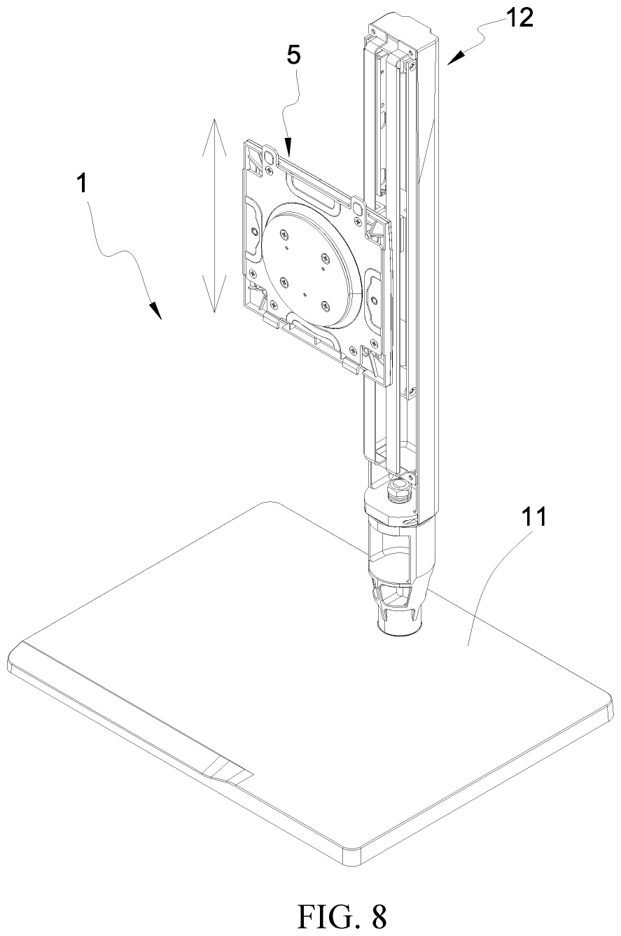

In the present invention, the supporting member 12 is structured such that the supporting member rotating portion 122 is formed with the receptacle 1222, while the supporting member mounting portion 121 is provided with the rotation stop 1212, so that the present invention achieves an effect of rotation, as shown in FIG. 7. Further, in the present invention, the supporting member 12 is structured to include the longitudinally movable member 3, and the longitudinally movable member 3 applies a frictional force with respect to the friction member 32 and the friction track 42 of the enclosure 4 by means of a spring force applied from the plurality of elastic members 41, so that the present invention achieves an effect of longitudinal movability, as shown in FIG. 8. Further, the screen fixing portion 5 is structured to include the symmetric elastic members 51 and the symmetric friction members 52, and an effect of adjusting the elevational angle of the screen fixing portion 5 is achieved, as shown in FIG. 9. Further, the screen fixing portion 5 is structured to include the rotating disc 53, and an effect of adjusting a sideway rotating angle of the screen fixing portion 5 is achieved, as shown in FIG. 10. In summary of the description provided above, the present invention may provide effects of adjustment of vertical position, elevational angle, sideway rotating angle, and angle of rotation.

I claim:

1. A screen support frame, comprising:
a screen support frame, wherein the screen support frame comprises a base and a supporting member, the supporting member comprising a supporting member mounting portion and a supporting member rotating portion, the supporting member mounting portion having one end mounted to the base, the supporting member mounting portion having an opposite end on which a protrusion and a rotation stop are formed, the supporting member rotating portion comprising a receiving hole and receptacle formed therein, wherein the protrusion of the supporting member mounting portion is disposed in the receiving hole of the supporting member rotating portion; the supporting member rotating portion comprises a pair of rails and a longitudinally movable member arranged between the rails, the longitudinally movable member having a side surface from which a frontward projection arm extends outwards, the longitudinally movable member having an opposite side that is provided with a friction member and a plurality of elastic member receiving troughs, an enclosure being provided to enclose the supporting member rotating portion, a plurality of elastic members being arranged in an interior of the enclosure, the elastic members being respectively disposed in the elastic member receiving troughs of the longitudinally movable member; a screen fixing portion is arranged such that the screen fixing portion is mounted to the frontward projection arm of the longitudinally movable member of the supporting member rotating portion, the screen fixing portion being provided with a group of symmetric elastic members and a group of symmetric friction members.

2. The screen support frame according to claim 1, wherein the rotation stop of the supporting member mounting portion is disposed in the receptacle of the supporting member rotating portion.

3. The screen support frame according to claim 1, wherein the enclosure is provided with a friction track.

4. The screen support frame according to claim 1, wherein the longitudinally movable member is provided with a friction adjusting member.

5. The screen support frame according to claim 1, wherein the screen fixing portion is provided with a rotating disc.

6. The screen support frame according to claim 1, wherein the supporting member is provided with a front cover and a rear cover.
